(19) United States
(12) Patent Application Publication
(10) Pub. No.: US 2018/0362874 A1
(43) Pub. Date: Dec. 20, 2018

(54) LUBRICANT FOR MAGNETIC RECORDING MEDIA, AND MAGNETIC RECORDING MEDIUM

(71) Applicant: DEXERIALS CORPORATION, Shinagawa-ku, Tokyo (JP)

(72) Inventors: Nobuo Tano, Shinagawa-ku, Tokyo (JP); Kouki Hatsuda, Shinagawa-ku, Tokyo (JP); Hirofumi Kondo, Shinagawa-ku, Tokyo (JP)

(21) Appl. No.: 15/780,171

(22) PCT Filed: Dec. 6, 2016
(86) PCT No.: PCT/JP2016/086227

§ 371 Date: May 30, 2018

(30) Foreign Application Priority Data
Dec. 7, 2015 (JP) 2015-238878

(51) Int. Cl. C10M 105/72; G11B 5/725

(52) U.S. Cl. CPC C10M 105/72; G11B 5/725; C10N 2240/204; C10M 2219/09; C10N 2220/04; C10M 2219/104

(57) ABSTRACT

Provided is a lubricant for magnetic recording medium, where the lubricant includes an ionic liquid including an anionic component and a cationic component, wherein the anionic component includes a fluorine-containing chain having a number average molecular weight of 1,500 or less, the cationic component is a cation of cyclic amidine, and the cation of the cyclic amidine includes a fluorine-containing chain that is either a perfluoroalkyl chain or a perfluoropolyether chain.

### TECHNICAL FIELD

The present invention relates to a lubricant for magnetic recording medium, and a magnetic recording medium using the lubricant.

### BACKGROUND ART

As recording density of a magnetic disk increases, a gap between a head and the disk has been getting narrower year by year. Recently, the gap has become on the order of from several nanometers to sub-nanometers. Therefore, abrasion of a disk tends to occur through contact with a head, leading to low recording reliability.

In order to prevent abrasion of a hard disk (HD) through contact, therefore, a protective carbon layer and a lubricant layer are disposed on a surface of the hard disk. Typically, perfluoropolyether (PFPE) having polar functional groups such as hydroxyl groups, where the PFPE is represented by the structural formula below, is used for the lubricant layer (see, for example, PTL 1 and PTL 2).

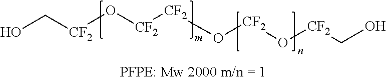

It has been known that such PFPE having terminal functional groups is adsorbed on a protective carbon layer to exhibit high abrasion resistance, evaporation resistance, and scattering resistance even when the lubricant layer is formed into a thin film, hence such PFPE has been often used for current HDs (see, for example, NPL 1).

It has been known that even a thin film, such as a film on the order of a monolayer, of PFPE exhibits high abrasion resistance. Naturally, the thickness of PFPE cannot be made any thinner than the monolayer. Therefore, a thickness of PFPE depends on a molecular weight of PFPE for use. A further increase of recording density is expected in the future and therefore reduction in a film thickness and reduction in a molecular weight are expected. Since deteriorations in heat resistance and scattering resistance are expected when a molecular weight is reduced, there is a limitation in achieving high recording density with reduction in a molecular weight of PFPE.

As a method for further improving a recording capacity and recording speed of a magnetic disk, a recording system called a heat-assist magnetic recording (HAMR) system has been developed recently. According to the HAMR system, improvements in a recording capacity, speed, and reliability can be realized by locally heating a recording section by near-field light, and recording and reproducing a magnetic field with applying thermal offset.

In this system, however, a disk is locally heated to around 200° C. (see NPL 2). Therefore, a lubricant used for this system needs to have thermal stability capable of resisting to a temperature of 200° C. or higher (preferably 250° C. or higher considering long term durability). The above-described PFPE however has a problem that thermal stability thereof is insufficient.

As a method for improving thermal stability of a lubricant, there is a method where a lubricant is formed into an ionic liquid. Examples thereof include a case where PFPE having acids at terminals and alkyl amine are allowed to react to form an ammonium salt-based ionic liquid. It has been reported that, according to the method as described, excellent friction resistance and lubrication properties are exhibited with maintaining a high thermal decomposition temperature.

Typically, a lubricant for HD is diluted with a fluorine-based solvent [e.g., 2H,3H-decafluoropentane (manufacturer: Du Pont-Mitsui Fluorochemicals Company, Ltd. (Vertrel XF)) etc.] and the diluted lubricant is then used for dip coating (see, for example, PTL 3). The above-described ionic liquid however has a problem that the ionic liquid has poor solubility to a fluorine-based solvent hence the ionic liquid cannot be uniformly applied. In order to realize practical use of an ionic liquid-type lubricant, high solubility to a fluorine-based solvent is required.

Furthermore, HD needs abrasion resistance such that it hardly crashes even when HD is repeatedly abraded. As one method for improving abrasion resistance, an improvement in fluidity of a lubricant is known (see NPL 3 and PTL 4). It has been known that a lubricant layer is made thin by pressure and contact applied when a head is passed above a base material. If the lubricant layer remains thin, abrasion of the head tends to occur when there is a contact between the head and the disk. In other words, durability of the head becomes poor when the lubricant has low fluidity or the lubricant is a solid. When the lubricant has high fluidity, however, the thinned lubricant can be recovered by backfilling, resulting in high abrasion resistance. Accordingly, it is considered important that a lubricant is a liquid at room temperature at which a recording medium is used.

### CITATION LIST

### Patent Literature

PTL 1: Japanese Patent Application Laid-Open (JP-A) No. 2006-70173
PTL 2: JP-A No. 2014-191847
PTL 3: JP-A No. 2008-75000
PTL 4: JP-A No. 2007-231056

### Non-Patent Literature

NPL 1: B. Bhushan, Tribology and Mechanics of Magnetic Storage Device, Springer (1996)
NPL 2: Fuji Electronic Journal, 2012, vol. 85, no. 4, pp. 329-332
NPL 3: IDEMA Japan News, No. 58, pp. 1-4

### SUMMARY OF INVENTION

### Technical Problem

The present invention aims to solve the above-described various problems existing in the art and to achieve the following object. Specifically, the present invention has an object to provide a lubricant for magnetic recording medium, which has excellent thermal stability and solubility to a fluorine-based solvent, as well as excellent fluidity, and to provide a magnetic recording medium using the lubricant.

### Solution to Problem

Means for solving the problems are as follows.

<1> A lubricant for magnetic recording medium including:

an ionic liquid including an anionic component and a cationic component, wherein the anionic component includes a fluorine-containing chain having a number average molecular weight of 1,500 or less,

the cationic component is a cation of cyclic amidine, and
the cation of the cyclic amidine includes a fluorine-containing chain that is either a perfluoroalkyl chain or a perfluoropolyether chain.
<2> The lubricant for magnetic recording medium according to <1>, wherein the ionic liquid is represented by General Formula (1) below,

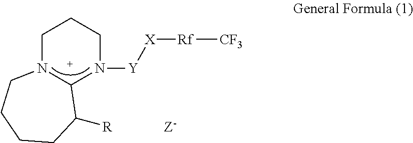

where, in General Formula (1), Rf is a perfluoropolyether chain having, as a repeating unit, a perfluoroalkyloxy chain having from 1 to 4 carbon atoms,
X is an alkylene group having 2 or more carbon atoms, an oxyalkylene group having 1 or more carbon atoms and 1 or more repeating units, or any combination thereof,
Y is a single bond or a divalent linking group,
R is a hydrogen atom or a hydrocarbon group having from 1 to 22 carbon atoms, and
Z⁻ is the anionic component.
<3> The lubricant for magnetic recording medium according to <1> or <2>, wherein the anionic component is a sulfonic acid anion including the fluorine-containing chain, a sulfonyl imide anion including the fluorine-containing chain, or sulfonyl methide anion including the fluorine-containing chain.
<4> The lubricant for magnetic recording medium according to <2> or <3>, wherein, in General Formula (1), the number of atoms in a straight chain connecting *1 and *2 of a divalent group represented by a structural formula below is 2 or greater,

*¹—Y—X—*².

<5> A magnetic recording medium including:

a non-magnetic support;

a magnetic layer on the non-magnetic support; and

the lubricant for magnetic recording medium according to any one of <1> to <4>, where the lubricant is on the magnetic layer.

### Advantageous Effects of Invention

The present invention can solve the above-described various problems existing in the art, and can provide a lubricant for magnetic recording medium, which has excellent thermal stability and solubility to a fluorine-based solvent, as well as excellent fluidity, and a magnetic recording medium using the lubricant.

### BRIEF DESCRIPTION OF DRAWINGS

FIG. 1 is a cross-sectional view illustrating one example of a hard disk according to one embodiment of the present invention.

FIG. 2 is a cross-sectional view illustrating one example of a magnetic tape according to one embodiment of the present invention.

### DESCRIPTION OF EMBODIMENTS

### (Lubricant for Magnetic Recording Medium)

A lubricant for magnetic recording medium of the present invention includes an ionic liquid, and may further include other ingredients according to the necessity.

### <Ionic Liquid>

The ionic liquid includes an anionic component and a cationic component. Specifically, the ionic liquid is composed of the anionic component and the cationic component.

The present inventors diligently performed researches in order to provide a lubricant for magnetic recording medium having excellent thermal stability and solubility to a fluorine-based solvent as well as excellent fluidity. As a result, the present inventors have found that a lubricant for magnetic recording medium having excellent thermal stability and solubility to a fluorine-based solvent as well as excellent fluidity can be obtained, when an ionic liquid including an anionic component and a cationic component included in the lubricant for magnetic recording medium satisfies the following structures 1 to 3.

Structure 1: The anionic component includes a fluorine-containing chain having a number average molecular weight of 1,500 or less.
Structure 2: The cationic component is a cation of cyclic amidine.
Structure 3: The cation of cyclic amidine includes a fluorine-containing chain that is a perfluoroalkyl chain or a perfluoropolyether chain.

### «Anionic Component»

The anionic component includes a fluorine-containing chain. The fluorine-containing chain does not include a hydrogen atom.

Examples of the fluorine-containing chain include a fluorine atom, a perfluorocarbon chain, and a perfluoropolyether chain.

Examples of the perfluorocarbon chain include a perfluoroalkyl chain and a perfluoroalkylene chain.

In the case where there is one fluorine atom in one chain of the anionic component, the fluorine-containing chain is composed only of the fluorine atom. In the case where there is one fluorine atom in one chain of the anionic component, namely, the fluorine atom itself is the fluorine-containing chain.

A number average molecular weight (Mn) of the fluorine-containing chain in the anionic component is 1,500 or less, preferably 500 or less, and more preferably from 200 to 500. When the number average molecular weight is greater than 1,500, it may be disadvantageous in terms of floating properties. The disadvantage in terms of floating properties means the following.

Within a hard disk, a head is present extremely close to a disk (may be referred to as a medium) but without contact with the disk. When the number average molecular weight is greater than 1,500, the head tends to be brought into contact with the disk.

For example, the number average molecular weight is determined by fluorine nuclear magnetic resonance (¹⁹F-NMR).

The fluorine-containing chain is preferably a fluorine-containing chain represented by General Formula (I-1) below in view of solubility and antifriction properties.

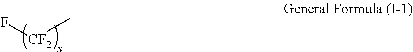

In General Formula (I-1) above, x is an integer of from 0 to 21, the lower limit of x is preferably 1 and more preferably 2, and the upper limit of x is preferably 20 and more preferably 10.

When x is 0, the fluorine-containing chain represented by General Formula (I-1) above is a fluorine atom. When x is 1 or greater, the fluorine-containing chain represented by General Formula (I-1) is a perfluoroalkyl chain.

The perfluoropolyether chain is preferably a fluorine-containing chain represented by General Formula (I-2) below in terms of solubility and antifriction properties.

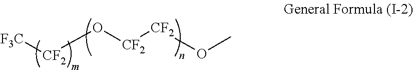

In General Formula (I-2), m is an integer of from 1 to 10 and preferably from 1 to 6, and n is an integer of from 2 to 10 and preferably from 2 to 6.

The anionic component is preferably a sulfonic acid anion having the fluorine-containing chain, a sulfonyl imide anion having the fluorine-containing chain, or a sulfonyl methide anion having the fluorine-containing chain in view of heat resistance.

An acid that is a source of the anionic component is preferably represented by any of General Formulae (I-A) to (I-G) below in view of heat resistance.

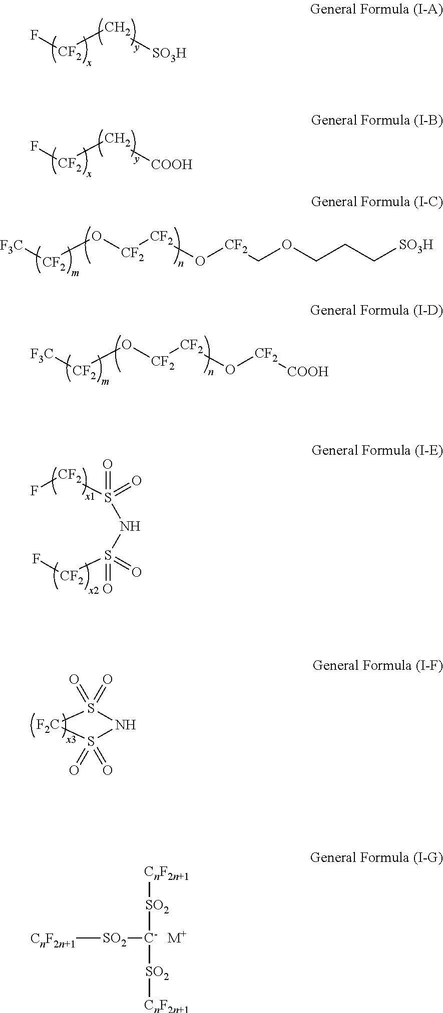

In General Formula (I-A) and General Formula (I-B) above, x is an integer of from 0 to 21, and y is an integer of from 0 to 6 and preferably an integer of from 0 to 2. Examples of x of General Formula (I-A) and General Formula (I-B) above are, for example, identical to the examples of x of General Formula (I-1) above.

In General Formula (I-C) and General Formula (I-D) above, m is an integer of from 1 to 10 and preferably an integer of from 1 to 6, and n is an integer of from 2 to 10 and preferably an integer of from 2 to 6.

In General Formula (FE) above, x1 and x2 are each independently an integer of from 0 to 20. Examples of x1 and x2 are, for example, identical to the examples of x of General Formula (I-1) above.

In General Formula (I-F), x3 is an integer of from 1 to 20 and preferably an integer of from 1 to 10.

In General Formula (I-G), n is an integer of from 1 to 20 and preferably an integer of from 1 to 10, and M is a monovalent metal atom and preferably an alkali metal. Examples of the alkali metal include sodium and potassium.

Note that, in General Formula (I-A) and General Formula (I-B) above, the —(CH₂)y- chain includes hydrogen atoms bonded to carbon atoms, and therefore is not included in the perfluoroalkyl chain. Specifically, the —(CH₂)y- chain is not part of the perfluoroalkyl chain.

In General Formula (I-C) above, the —CH₂OCH₂CH₂CH₂— chain includes hydrogen atoms bonded to carbon atoms, and therefore is not included in the perfluoropolyether chain. Specifically, the —CH₂OCH₂CH₂CH₂— chain is not part of the perfluoropolyether chain.

When x1 and x2 are 0 in General Formula (I-E) above, fluorine atoms bonded to S each independently constitute a fluorine-containing chain.

A number average molecular weight (Mn) of the fluorine-containing chain in the acid is 1,500 or less, preferably 500 or less, and more preferably from 200 to 500.

For example, the number average molecular weight is determined by fluorine nuclear magnetic resonance (¹⁹F-NMR).

For example, the anionic component is preferably represented by any of General formulae (I-I-A) to (I-I-G) below in view of heat resistance.

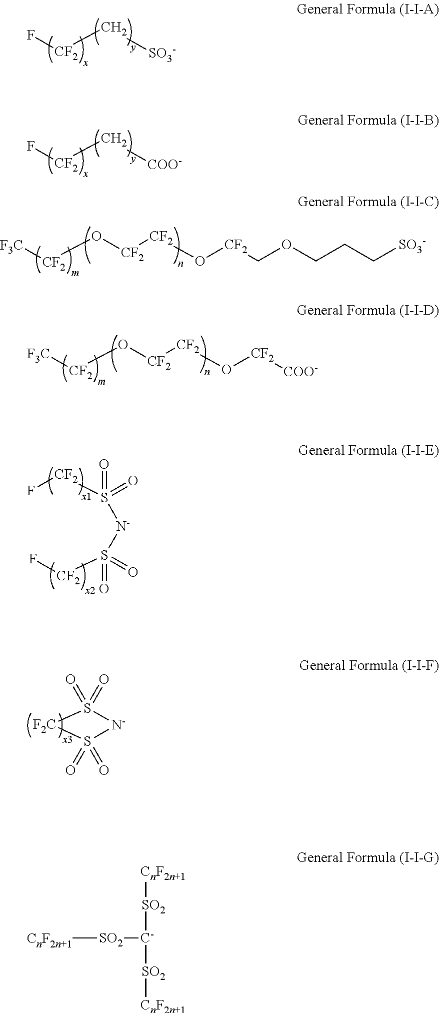

In General Formula (I-I-A) and General Formula (I-I-B) above, x is an integer of from 0 to 21, and y is an integer of from 0 to 6 and preferably an integer of from 0 to 2. Examples of x of General Formula (I-I-A) and General Formula (I-I-B) are, for example, identical to the examples of x of General Formula (I-1) above.

In General Formula (I-I-C) and General Formula (I-I-D) above, m is an integer of from 1 to 10 and preferably an integer of from 1 to 6, and n is an integer of from 2 to 10 and preferably an integer of from 2 to 6.

In General Formula (I-I-E) above, x1 and x2 are each independently an integer of from 0 to 20. For example, examples of x1 and x2 include the examples of x of General Formula (I-1) above.

In General Formula (I-I-F) above, x3 is an integer of from 1 to 20 and preferably an integer of from 1 to 10.

In General Formula (I-I-G) above, n is an integer of from 1 to 20 and preferably an integer of from 1 to 10.

Note that, in General Formula (I-I-A) and General Formula (I-I-B) above, the —(CH₂)y- chain includes hydrogen atoms bonded to carbon atoms, and therefore is not included in the perfluoroalkyl chain. Specifically, the —(CH₂)y- chain is not part of the perfluoroalkyl chain.

In General Formula (I-I-C) above, the —CH₂OCH₂CH₂CH₂— chain includes hydrogen atoms bonded to carbon atoms, and therefore is not included in the perfluoropolyether chain. Specifically, the —CH₂OCH₂CH₂CH₂— chain is not part of the perfluoropolyether chain.

When x1 and x2 are 0 in General Formula (I-I-E) above, fluorine atoms bonded to S each independently constitute a fluorine-containing chain.

### «Cationic Component»

The cationic component is a cation of cyclic amidine.

The cation of the cyclic amidine includes a fluorine-containing chain that is a perfluoroalkyl chain or a perfluoropolyether chain. The fluorine-containing chain does not include a hydrogen atom.

Since the cationic component is cyclic amidine, excellent thermal stability is obtained.

Since the cation of the cyclic amidine includes a fluorine-containing chain that is a perfluoroalkyl chain or a perfluoropolyether chain, moreover, excellent solubility to a fluorine-based solvent and a low melting point are obtained.

The perfluoroalkyl chain is preferably a fluorine-containing chain represented by General Formula (II-1) below in view of solubility and antifriction properties.

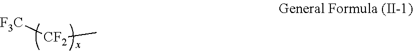

In General Formula (II-1) above, x is an integer of from 1 to 20 and preferably an integer of from 1 to 10.

The perfluoropolyether chain is preferably a fluorine-containing chain represented by General Formula (II-2) below in view of solubility and antifriction properties.

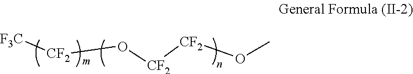

In General Formula (II-2) above, m is an integer of from 1 to 10 and preferably an integer of from 1 to 6, and n is an integer of from 2 to 10 and preferably an integer of from 2 to 6.

The cationic component is preferably represented by General Formula (II-A) below because a low melting point, high solubility to a fluorine-based solvent, and thermal stability are obtained with desirable balance.

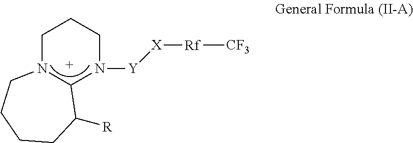

In General Formula (II-A), Rf is a perfluoropolyether chain including a perfluoroalkyloxy chain having from 1 to 4 carbon atoms as a repeating unit;

X is an alkylene group having 2 or more carbon atoms, an oxyalkylene group having 1 or more carbon atoms and 1 or more repeating units, or any combination thereof;
Y is a single bond or a divalent linking group; and
R is a hydrogen atom or a hydrocarbon group having from 1 to 22 carbon atoms.

Examples of CF₃—Rf— include a fluorine-containing chain represented by General Formula (II-2) above.

### —X—

Examples of the alkylene group having 2 or more carbon atoms of X include an alkylene group having from 2 to 6 carbon atoms (C₂-C₆ alkylene group).

Examples of the oxyalkylene group having 1 or more carbon atoms and one or more repeating units of X include an oxy C₂-C₆ alkylene group having from 2 to 10 repeating units.

### —Y—

The divalent linking group of Y is preferably a linking group having from 1 to 10 atoms and more preferably a linking group having from 1 to 6 atoms. Y is a linking group used for the convenience of synthesis when the —X—Rf—CF₃ group is introduced into a diazabicycloundecene structure that is a main skeleton of the cationic component.

Examples of the divalent linking group include the following linking groups.

[Divalent linking groups]

### —O—

### —S—

### —C(O)O—

### —NHCO—

### —SO₃—

### —HNCONH—

### —R—

Examples of the hydrocarbon group having from 1 to 22 carbon atoms of R include an alkyl group having from 1 to 22 carbon atoms.

Since R is a hydrocarbon group having from 1 to 22 carbon atoms, abrasion resistance improves.

In General Formula (II-A), the number of atoms in a straight chain connecting *1 and *2 of a divalent group represented by a structural formula below is preferably 2 or greater and more preferably from 2 to 6. As a result, strong basicity of the cyclic amidine can be maintained and an ionic liquid having excellent thermal stability is obtained.

*¹—Y—X—*²

The ionic liquid is preferably represented by General Formula (1) below.

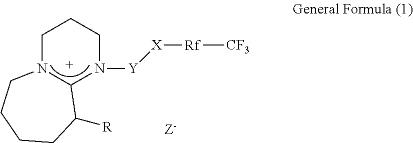

In General Formula (1) above, Rf is a perfluoropolyether chain having, as a repeating unit, a perfluoroalkyloxy chain having from 1 to 4 carbon atoms;

X is an alkylene group having 2 or more carbon atoms, an oxyalkylene group having 1 or more carbon atoms and 1 or more repeating units, or any combination thereof
Y is a single bond or a divalent linking group;
R is a hydrogen atom or a hydrocarbon group having from 1 to 22 carbon atoms; and
Z⁻ is the anionic component.

Specific examples and preferable embodiments of Rf, X, Y, and R in General Formula (1) are identical to specific examples and preferable embodiments of Rf, X, Y, and R in General Formula (II-A) above.

A melting point of the ionic liquid is preferably 25° C. or lower and more preferably 10° C. or lower. The lower limit of the melting point of the ionic liquid is not particularly limited and may be appropriately selected depending on the intended purpose. The melting point of the ionic liquid is preferably −100° C. or higher.

For example, the melting point can be determined by differential scanning calorimetry.

Since the melting point of the ionic liquid is room temperature or lower, the ionic liquid has fluidity at room temperature.

### <Other Ingredients>

Examples of the above-mentioned other ingredients include lubricants, extreme-pressure agents, anti-rust agents, and solvents known in the art.

### «Known Lubricant»

As the lubricant, the ionic liquid may be used alone, or the ionic liquid may be used in combination with any lubricant known in the art. Examples of the known lubricant include long-chain carboxylic acids, long-chain carboxylic acid esters, perfluoroalkyl carboxylic acid esters, carboxylic acid perfluoroalkyl esters, perfluoroalkyl carboxylic acid perfluoroalkyl esters, and perfluoropolyether derivatives.

### «Extreme-Pressure Agent»

In order to maintain a lubrication effect under severe conditions, the lubricant for magnetic recording medium may be used in combination with an extreme-pressure agent at a blending ratio of about 30:70 to about 70:30 based on a mass ratio. The extreme-pressure agent reacts with a metal surface to form a reaction product coating film due to friction heat generated when a metal contact is partially formed within a boundary lubrication region, to thereby perform a function of preventing friction and abrasion. As the extreme-pressure agent, for example, any of a phosphorous-based extreme-pressure agent, a sulfur-based extreme-pressure agent, a halogen-based extreme-pressure agent, an organic metal-based extreme-pressure agent, and a complex-based extreme-pressure agent can be used.

### «Anti-Rust Agent»

The anti-rust agent is not particularly limited as long as the anti-rust agent is an anti-rust agent that can be generally used for this type of a magnetic recording medium. Examples of the anti-rust agent include phenols, naphthols, quinones, heterocyclic compounds each including a nitrogen atom, heterocyclic compounds each including an oxygen atom, and heterocyclic compounds each including a sulfur atom. Moreover, the anti-rust agent may be blended as a lubricant. Alternatively, the anti-rust agent may be disposed by dividing into 2 or more layers, for example, by forming a magnetic layer on a non-magnetic support, coating an upper part of the magnetic layer with an anti-rust agent layer, followed by coating with a lubricant layer.

### «Solvent»

Examples of the solvent include organic solvents. Examples of the organic solvents include fluorine-based solvents and alcohol-based solvents. Examples of the alcohol-based solvent include isopropyl alcohol (IPA) and ethanol. These solvents may be used alone or in combination.

### (Magnetic Recording Medium)

A magnetic recording medium of the present invention includes a non-magnetic support, a magnetic layer, and the lubricant for magnetic recording medium of the present invention, and may further include other members according to the necessity.

The magnetic layer is formed on the non-magnetic support. Specifically, the magnetic layer is arranged on or above the non-magnetic support.

The lubricant for magnetic recording medium is formed on the magnetic layer. Specifically, the lubricant for magnetic recording medium is arranged on or above the magnetic layer.

The lubricant can be applied for a so-called metal thin film magnetic recording medium, in which a magnetic layer is formed on a surface of a non-magnetic support by a method, such as vapor deposition and sputtering. Moreover, the lubricant can be also applied for a magnetic recording medium having a structure where an undercoat layer is disposed between a non-magnetic support and a magnetic layer. Examples of such a magnetic recording medium include magnetic disks and magnetic tapes.

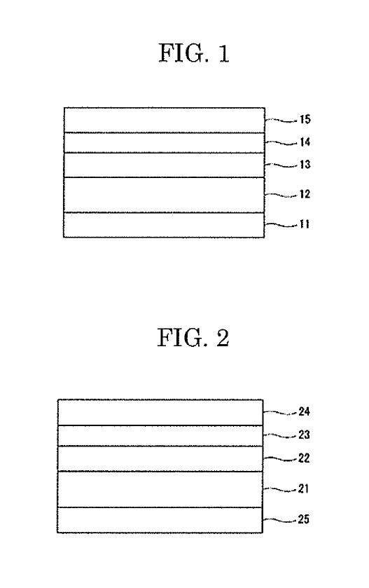

FIG. 1 is a cross-sectional view illustrating one example of a hard disk. The hard disk has a structure where a substrate 11, an undercoat layer 12, a magnetic layer 13, a protective carbon layer 14, and a lubricant layer 15 are sequentially laminated.

Moreover, FIG. 2 is a cross-sectional view illustrating one example of a magnetic tape. The magnetic tape has a structure where a back coat layer 25, a substrate 21, a magnetic layer 22, a protective carbon layer 23, and a lubricant layer 24 are sequentially laminated.

In the magnetic disk illustrated in FIG. 1, the substrate 11 and the undercoat layer 12 correspond to a non-magnetic support. In the magnetic tape illustrated in FIG. 2, the substrate 21 corresponds to a non-magnetic support. When a substrate having rigidity, such as an Al alloy plate and a glass plate, is used as a non-magnetic support, a surface of the substrate may be hardened by forming an oxide film formed by anodizing, or a Ni—P coating on the surface of the substrate.

The magnetic layers 13 and 22 are formed as continuous films by a method, such as plating, sputtering, vacuum vapor deposition, and plasma CVD. Examples of the magnetic layers 13 and 22 include: longitudinal magnetic recording metal magnetic films formed of metals (e.g., Fe, Co, and Ni), Co—Ni-based alloys, Co—Pt-based alloys, Co—Ni—Pt-based alloys, Fe—Co-based alloys, Fe—Ni-based alloys, Fe—Co—Ni-based alloys, Fe—Ni—B-based alloys, Fe—Co—B-based alloys, or Fe—Co—Ni—B-based alloys; and perpendicular magnetic recording metal magnetic thin films, such as Co—Cr-based alloy thin films and Co—O-based thin films.

In the case where a longitudinal magnetic recording metal magnetic thin film is formed, particularly, a non-magnetic material, such as Bi, Sb, Pb, Sn, Ga, In, Ge, Si, and Tl, is formed as the undercoat layer 12 on a non-magnetic support in advance, and a metal magnetic material is deposited through vapor deposition or sputtering performed in a perpendicular direction to diffuse the non-magnetic material into the magnetic metal thin film, to thereby improve a coercive force as well as eliminating orientation to assure in-plane isotropy.

Moreover, a hard protective layer, such as a carbon film, a diamond-like carbon film, a chromium oxide film, and SiO₂ film, may be formed on a surface of the magnetic layer 13 or 22.

Examples of a method for making such a metal thin film magnetic recording medium retain the lubricant for magnetic recording medium include a method for top coating a surface of the magnetic layer 13 or 22, or a surface of the protective carbon layer 14 or 23, as illustrated in FIG. 1 and FIG. 2. A coating amount of the lubricant for magnetic recording medium is preferably from 0.1 mg/m² to 100 mg/m², more preferably from 0.5 mg/m² to 30 mg/m², and particularly preferably from 0.5 mg/m² to 20 mg/m².

As illustrated in FIG. 2, moreover, a metal thin film magnetic tape may optionally have a back coat layer 25 in addition to a metal magnetic thin film that is the magnetic layer 22.

The back coat layer 25 is formed by adding a carbon-based powder for imparting conductivity, or an inorganic pigment for controlling a surface roughness to a resin binder, and applying the resultant mixture.

As another embodiment, moreover, the lubricant can be applied for a so-called coating-type magnetic recording medium, in which a magnetic coating film is formed as a magnetic layer by applying a magnetic coating material onto a surface of a non-magnetic support. In the coating-type magnetic recording medium, the non-magnetic support, a magnetic powder constituting the magnetic coating film, and the resin binder for use can be selected from any of those known in the art.

Examples of the non-magnetic support include: polymer supports formed of polymer materials, represented by polyesters, polyolefins, cellulose derivatives, vinyl-based resins, polyimides, polyamides, polycarbonates, etc.; metal substrates formed of aluminium alloys, titanium alloys, etc.; ceramic substrates formed of alumina glass, etc.; and glass substrates. Moreover, a shape of the non-magnetic support is not particularly limited, and may be any form, such as a tape shape, a sheet shape, and a drum shape. Moreover, the non-magnetic support may be subjected to a surface treatment by which fine irregularities are formed, in order to control the surface texture of the non-magnetic support.

Examples of the magnetic powder include: ferromagnetic iron oxide-based particles, such as γ-Fe₂O₃, and cobalt-coated γ-Fe₂O₃; ferromagnetic chromium dioxide-based particles; ferromagnetic metal-based particles formed of a metal, such as Fe, Co, and Ni, or an alloy containing any of the above-listed metals; and hexagonal ferrite particles in the form of hexagonal plates.

Examples of the resin binder include: polymers of vinyl chloride, vinyl acetate, vinyl alcohol, vinylidene chloride, acrylic acid ester, methacrylic acid ester, styrene, butadiene, acrylonitrile, etc.; copolymers including two or more from the above-listed monomers in combination; polyurethane resins; polyester resins; and epoxy resins. In order to improve dispersibility of the magnetic powder, hydrophilic polar groups, such as carboxylic acid groups, carboxyl groups, and a phosphoric acid group, may be introduced into the binders.

In addition to the magnetic powder and the resin binder, additives, such as a dispersing agent, an abrasive, an antistatic agent, and an anti-rust agent, may be added to the magnetic coating film.

As a method for making such a coating-type magnetic recording medium retain the lubricant for magnetic recording medium, there are a method where the lubricant is internally added to the magnetic layer constituting the magnetic coating film formed on the non-magnetic support, a method where the lubricant is applied onto a surface of the magnetic layer as top coating, and a combination of the methods described above. In the case where the lubricant for magnetic recording medium is internally added to the magnetic coating film, moreover, the lubricant is added in an amount of from 0.2 parts by mass to 20 parts by mass relative to 100 parts by mass of the resin binder.

In the case where the lubricant for magnetic recording medium is applied onto a surface of the magnetic layer as top coating, moreover, the applying amount of the lubricant is preferably from 0.1 mg/m² to 100 mg/m², and more preferably from 0.5 mg/m² to 20 mg/m². As the deposition method when the lubricant for magnetic recording medium is applied as top coating, the ionic liquid is dissolved in a solvent to prepare a solution, and the obtained solution is applied or sprayed, or a magnetic recording medium may be dipped in the solution.

The solvent is preferably a fluorine-based solvent. Examples of the fluorine-based solvent include hydrofluoroethers [e.g., C₃F₇OCH₃, C₄F₉OCH₃, C₄F₉OC₂H₅, C₂F₅CF(OCH₃)C₃F₇, and C₅H₂F₁₀].

The fluorine-based solvent may be a commercial product. Examples of the commercial product include: Novec™ 7000, 7100, 7200, 7300, and 71IPA available from 3M Company; and Vertrel XF, and X-P10 available from Du Pont-Mitsui Fluorochemicals Company, Ltd.

Use of the lubricant for magnetic recording medium of the present invention can exhibit an excellent lubrication effect to reduce a friction coefficient and can obtain high thermal stability even when a lubrication layer having a small thickness is formed. Moreover, the lubrication effect is not impaired even under severe conditions, such as high temperatures, low temperatures, high humidity, and low humidity.

Accordingly, a magnetic recording medium, to which the lubricant for magnetic recording medium is applied, exhibits excellent running performances, abrasion resistance, durability, etc., because of the lubrication effect, even when a lubrication layer having a small thickness is formed, and moreover can improve thermal stability.

### EXAMPLES

Specific examples of the present invention will be explained hereinafter. Note that, the examples shall not be construed as limiting the scope of the present invention.

### Example 1

### <Synthesis of 1-PFTEG Substituted DBU.PFBSI Salt>

1-PFTEG substituted DBU.PFBSI salt represented by the following structural formula was synthesized according to the following method.

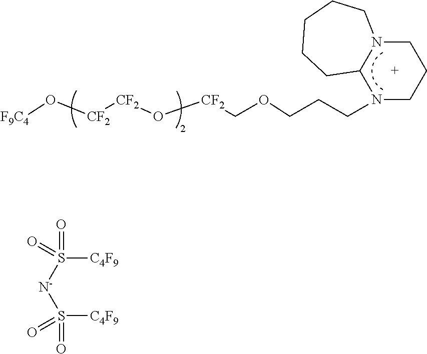

### «Step 1-1»

A flask equipped with a stirrer and a cooling tube was charged with 44.7 g (473 mmol) of 3-chloro-1-propanol (manufacturer: Tokyo Chemical Industry Co., Ltd.), 134 g (703 mmol) of p-toluenesulfonyl chloride (manufacturer: Tokyo Chemical Industry Co., Ltd.), 305 g of toluene (manufacturer: Wako Pure Chemical Industries, Ltd.), and as a base, 71.1 g (703 mmol) of triethylamine (manufacturer: KANTO CHEMICAL CO., INC.), and the resultant mixture was stirred for 24 hours at room temperature. After the stirring, the reaction solution was filtered, and diethyl ether was added to the resultant. The ether layer was washed with water and diluted hydrochloric acid, and the solvent was removed by an evaporator. Thereafter, the obtained crude product was purified by silica gel column chromatography [hexane+acetone=9+1→3+1 (mass ratio)]. After the purification, the fraction was concentrated to thereby obtain a target, 3-chloropropyltosylate, at a yield of 90%.

### «Step 1-2»

A flask equipped with a stirrer, a thermometer, and a cooling tube was charged with 54.9 g (100 mmol) of perfluorotriethylene glycol monobutyl ether (PFTEG-OH) (manufacturer: FluoroChem Ltd) and 44.1 g (177 mmol) of 3-chloropropyltosylate, and as a solvent, 100 g of methaxylenehexafluoride (manufacturer: Wako Pure Chemical Industries, Ltd.), and the resultant mixture was stirred at room temperature. During the stirring, 24.5 g (177 mmol) of potassium carbonate (manufacturer: Wako Pure Chemical Industries, Ltd.) and 2.81 g of a 40% by mass tetrabutylammonium hydroxide aqueous solution (manufacturer: Tokyo Chemical Industry Co., Ltd.) were added, and the mixture was heated and stirred for 10 hours at 80° C. To the resultant reaction solution, water and Novec 7100 (available from 3M Company) were added, liquid separation extraction was performed, followed by washing with hydrochloric acid. Thereafter, the Novec layer was concentrated by an evaporator. The obtained crude product was purified by silica gel column chromatography [hexane→hexane+acetone=9+1 (mass ratio)]. The obtained fraction was concentrated to thereby obtain 3-chloropropylPFTEG represented by the following structural formula at a yield of 73%.

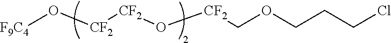

A structure of the synthesized 3-chloropropylPFTEG was confirmed by H-NMR and GC-MS.

First, it was confirmed from the result of H-NMR (in deuterated chloroform) that the peak positions were δ: 3.9-3.7 ppm (m, 4H), 3.7-3.5 ppm (q, 2H), and 2.1-1.9 ppm (quin, 2H). It was confirmed that the peak positions and the integration ratio were identical to the peak positions and integration ratio of the target.

Moreover, it was confirmed from the result of GC-MS that purity of the sample was 98 area % or greater.

### «Step 1-3»

A flask equipped with a stirrer, a thermometer, and a cooling tube was charged with 1.52 g (10 mmol) of DBU (diazabicycloundecene, manufacturer: Tokyo Chemical Industry Co., Ltd.), 7.03 g (11.2 mmol) of the 3-chloropropylPFTEG synthesized in «Step 1-2», and as a solvent 6 g of isopropanol, and the resultant mixture was heated under reflux for 7 hours.

The solvent was removed from the obtained mixture solution by an evaporator, followed by washing with hexane and a mixed solvent of hexane and diethyl ether. Thereafter, the resultant was again concentrated by the evaporator. To the obtained concentrated liquid, Novec 7100 was added. The resultant was filtered with a membrane filter of 0.2 μm, followed by vacuum drying at 80° C., to thereby obtain DBU-PFTEG chloride represented by the following structural formula at a yield of 64%. It was confirmed from the measurement result of LC-MS(ELSD) that about 99% of the synthesized DBU-PFTEG chloride was the target.

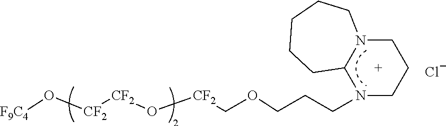

### «Step 1-4»

A flask equipped with a stirrer and a cooling tube was charged with 1.68 g (2.19 mmol) of the DBU-PFTEG chloride synthesized in «Step 1-3», and moreover 20 g of water, and the resultant mixture was stirred to dissolve the DBU-PFTEG chloride. Thereafter, a solution prepared by dissolving 1.42 g of lithium bis(nonafluorobutanesulfonyl)imide (manufacturer: Wako Pure Chemical Industries, Ltd.) in 15 g of water was introduced into the flask, and the resultant mixture was stirred for 18 hours. After the stirring, the obtained ionic liquid layer was washed with water. Thereafter, vacuum drying was performed to thereby obtain a target ionic liquid at a yield of 87%. The target was analyzed by LC-MS(ELSD) and the introduction of the anion and the purity of 98% were confirmed.

As described above, 1-PFTEG substituted DBU.PFBSI salt represented by the above-presented structural formula was obtained.

### Example 2

### <Synthesis of 1-PFTEG Substituted DBU-CpSI Salt>

1-PFTEG substituted DBU.CpSI salt represented by the following structural formula was synthesized according to the following method.

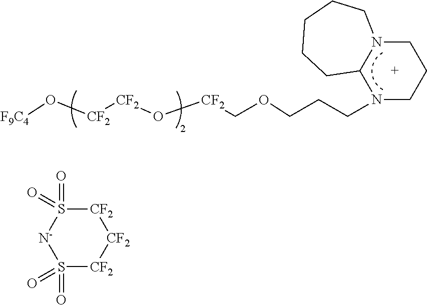

The synthesis, purification, and analysis were performed in the same manner as in «Step 1-4» of Example 1, except that the lithium salt was changed to lithium N,N-hexafluoro-1,3-disulfonylimide (manufacturer: Wako Pure Chemical Industries, Ltd.). As a result, the target ionic liquid was obtained at a yield of 89%.

### Example 3

### <Synthesis of 1-PFTEG Substituted DBU.PFBS Salt>

1-PFTEG substituted DBU.PFBS salt represented by the following structural formula was synthesized according to the following method.

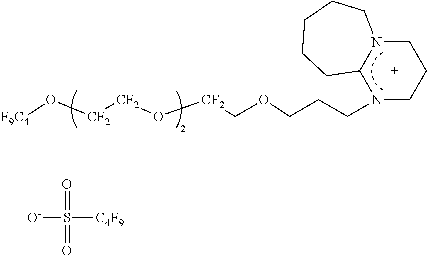

The synthesis, purification, and analysis were performed in the same manner as in «Step 1-4» of Example 1, except that the lithium salt was changed to potassium perfluorobutane sulfonate (manufacturer: Tokyo Chemical Industry Co., Ltd.). As a result, the target ionic liquid was obtained at a yield of 86%.

### Example 4

### <Synthesis of 1-PFTEG Substituted DBU.TFSM Salt>

1-PFTEG substituted DBU.TFSM salt represented by the following structural formula was synthesized according to the following method.

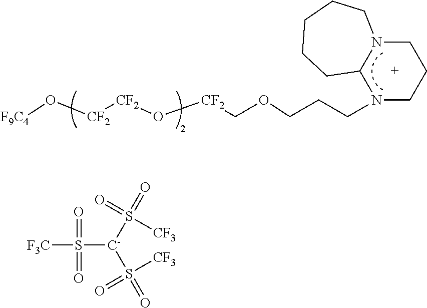

The synthesis was performed in the same manner as in «Step 1-4» of Example 1, except that the lithium salt was changed to potassium tris(trifluoromethanesulfonyl)methide (manufacturer: Central Glass Co., Ltd.) and the solvent was changed to acetone. The obtained target mixture solution was filtered, followed by concentrating the resultant. The ionic liquid layer was washed with water, ether, and hexane. Thereafter, vacuum drying was performed to thereby obtain a target ionic liquid at a yield of 94%. An analysis was performed by LC-MS in the same manner as in Example 1.

### Comparative Example 1

### <Synthesis of DMSA.CpSI Salt>

DMSA.CpSI salt represented by the following structural formula was synthesized according to the following method.

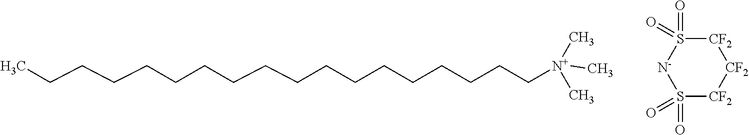 [SMILES: CCCCCCCCCCCCCCCCCC[N+](C)(C)C ; O=S1(=O)[N-]S(=O)(=O)C(F)(F)C(F)(F)C1(F)F]

The synthesis was performed in the same manner as in «Step 1-4» of Example 1, except that the lithium salt was changed to lithium N,N-hexafluoro-1,3-disulfonylimide (manufacturer: Wako Pure Chemical Industries, Ltd.), DBU-PFTEG chloride was changed to a 80% product of N,N,N-trimethylstearylammonium chloride (manufacturer: Wako Pure Chemical Industries, Ltd.), and the reaction was performed in water at a blending ratio that would give an equimolar ratio. As a result, a target was obtained at a yield of 91%.

### Comparative Example 2

### <Synthesis of DMSA.TFSM Salt>

DMSA.TFSM salt represented by the following structural formula was synthesized according to the following method.

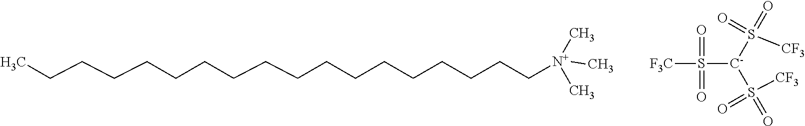 [SMILES: CCCCCCCCCCCCCCCCCC[N+](C)(C)C ; O=S(=O)([C-](S(=O)(=O)C(F)(F)F)S(=O)(=O)C(F)(F)F)C(F)(F)F]

The synthesis, purification, and identification were performed in the same manner as in Comparative Example 1, except that the lithium salt was changed to potassium tris(trifluoromethanesulfonyl)methide (manufacturer: Central Glass Co., Ltd.). A yield was 93%.

### Comparative Example 3

### <Synthesis of PFTEG Amine.Perfluorobutane Sulfonic Acid Salt>

PFTEG amine.perfluorobutane sulfonic acid salt represented by the following structural formula was synthesized according to the following method.

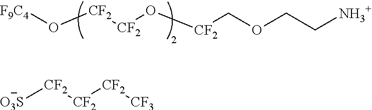

### «Step 2-1»

A flask equipped with a stirrer, a thermometer, and a cooling tube was charged with 21.9 g (40.0 mmol) of perfluorotriethylene glycol monobutyl ether (PFTEG-OH) (manufacturer: FluoroChem Ltd) and 18.9 g (80.0 mmol) of 2-chloroethyltosylate (manufacturer: Tokyo Chemical Industry Co., Ltd.), and as a solvent, 40 g of methaxylenehexafluoride (manufacturer: Wako Pure Chemical Industries, Ltd.), and the resultant mixture was stirred at room temperature. During the stirring, 11.1 g (80.3 mmol) of potassium carbonate (manufacturer: Wako Pure Chemical Industries, Ltd.) and 1.1 g of a 40% tetrabutylammonium hydroxide aqueous solution (manufacturer: Tokyo Chemical Industry Co., Ltd.) were added, and the mixture was heated and stirred for 15 hours at 80° C. To the resultant reaction solution, water and Novec 7100 (manufacturer: 3M Japan Limited) were added, liquid separation extraction was performed, and then the Novec layer was concentrated by an evaporator to thereby obtain 38.3 g of a colorless transparent liquid of a chlorotehylated PFTEG solution.

### «Step 2-2»

A flask equipped with a stirrer, a thermometer, and a cooling tube was charged with 37.3 g of the chlorotehylated PFTEG solution obtained in «Step 2-1», 28.37 g (153 mmol) of potassium phthalimide (manufacturer: Tokyo Chemical Industry Co., Ltd.), 0.3 g of sodium iodide (manufacturer: Wako Pure Chemical Industries, Ltd.), and 1.68 g (6.3 mmol) of 18-crown-6-ether (manufacturer: Aldrich), and as a solvent, 118 g of DMF (manufacturer: KANTO CHEMICAL CO., INC.), and the resultant mixture was stirred for 13 hours at 80° C. After concentrating the reaction solution by an evaporator, liquid separation extraction was performed in a water/Novec 7100 system to extract an organic layer. Moreover, the organic layer was washed twice with a 0.2 M sodium hydroxide aqueous solution, and the resultant organic layer was dried with magnesium sulfate. After removing the magnesium sulfate by filtration, the resultant was concentrated by an evaporator, followed by vacuum drying, to thereby obtain a phthalimidized product at a yield of 90% (including Step 2-1).

A structure of the synthesized phthalimidized product was confirmed by H-NMR (in deuterated chloroform), FT-IR, and GC-MS.

It was confirmed from the result of H-NMR (in deuterated chloroform) that the peak positions were δ: 7.8, 7.7, and 3.9-3.7 ppm, which were peaks derived from an aromatic ring in phthalimide and derived from a hydrocarbon chain, and that the integration ratio was matched.

From the FT-IR analysis, moreover, peaks derived from a carbonyl group in the phthalimide site could be confirmed at 1,711 cm⁻ and 1,774 cm⁻¹ and synthesis of a target was confirmed.

### «Step 2-3»

A flask equipped with a stirrer, a Y-shaped tube, a thermometer, and a cooling tube was charged with 24.5 g (34 mmol) of the phthalimidized product synthesized in «Step 2-2», 7.7 g (1.08 mol) of hydrazine hydrate (manufacturer: Wako Pure Chemical Industries, Ltd.), and 110 mL of ethanol. Thereafter, the resultant mixture was stirred under reflux (70° C. or higher) for 14 hours. To the obtained liquid, Novec 7100 was added. The resultant was subjected to liquid separation and was washed 3 times with a 1 mol/L sodium hydroxide aqueous solution. The obtained Novec layer was dehydrated with sodium sulfate, followed by filtration to thereby obtain a target solution. After filtering the obtained solution with a PP membrane filter having a pore diameter of 0.2 urn, the resultant was concentrated to thereby obtain 23.4 g of an aminated product (PFTEG amine).

It was confirmed from the GC-MS analysis that the peaks derived from PFTEG phthalimide (phthalimidized product) disappeared and the obtained PFTEG amine was a solution including Novec 7100 (11% by mass) and PFTEG-OH (8% by mass).

It was confirmed from the FT-IR analysis that the peaks derived from the carbonyl group in the phthalimide site present at 1,711 cm⁻¹ and 1,774 cm⁻¹ completely disappeared, and a peak derived from NH of amine was confirmed at near 3,600-3,100 cm⁻¹, hence synthesis of the target was confirmed.

### «Step 2-4»

A flask equipped with a cooling tube was charged with 6.68 g (7.80 mmol) of an about 69% PFTEG amine solution synthesized in «Step 2-3» and 2.39 g (7.97 mmol) of perfluorobutane sulfonic acid (abbreviation: PFBS, manufacturer: Tokyo Chemical Industry Co., Ltd.), and as a solvent, 15 g of Novec 7100, and the resultant mixture was stirred for 2 hours at room temperature. Thereafter, the resultant was concentrated by an evaporator, and decantation purification was performed using a mixed solution of ether+hexane [1+1 (mass ratio)] and water. After the washing, it could be confirmed that the washing liquid and the target solution had pH of 7 using pH testing paper. Therefore, the target solution was vacuum dried, to thereby obtain pale yellow PFTEG amine-perfluorobutane sulfonic acid salt at a yield of 68%.

### Comparative Example 4

<PFPE Tetraol Having a Molecular Weight of about 2,000>

Fomblin Z-TETRAOL (manufacturer: Solvay Specialty Polymers, the following structural formula) (molecular weight: about 2,000) was used.

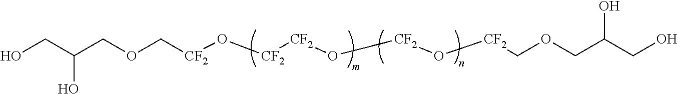

### <Evaluations>

The following evaluations were performed.

### «Solubility to Fluorine-Based Solvent»

The obtained product was added to a fluorine-based solvent (Vertrel XF, available from Du Pont-Mitsui Fluorochemicals Company, Ltd.) in a manner that a concentration of the product was to be 1% by mass, and the resultant was stirred with maintaining a temperature at 25° C. The solubility was evaluated based on the following evaluation criteria. The results are presented in Table 1.

### [Evaluation Criteria]

B: The product was dissolved in the fluorine-based solvent, and there was no sedimentation even when the solution was left to stand.
C: The product was insoluble to the fluorine-based solvent, or was temporarily dissolved but sedimentation occurs when the solution was left to stand.

TABLE 1

| | |
|---|---|
| Example | Comparative Example |

| 1 | 2 | 3 | 4 | 1 | 2 | 3 | 4 |
|---|---|---|---|---|---|---|---|
| B | B | B | B | C | C | B | B |

A test was performed using Vertrel XF, which was a solvent typically used for applying a lubricant to a hard disk.

It was found that Examples and Comparative Examples 3 and 4 were dissolved, but Comparative Examples 1 and 2 were not dissolved.

### «Measurement of Thermal Decomposition Temperature»

A weight reduction relative to a temperature was measured by TG-DTA (manufacturer: Seiko Instruments Inc., model number: EXSTAR6000) and a 5% weight reduction temperature was determined as a thermal decomposition temperature. As measuring conditions, heating speed was 10° C./min and an air flow rate was 200 mL/min.

The results are presented in Table 2.

### «Measurement of Melting Point»

An endothermic peak temperature was determined by DSC (manufacturer: Seiko Instruments Inc., and model number: EXSTAR6000), and the measured endothermic peak temperature was determined as a melting point. As measuring conditions, heating speed was 10° C./min, and the measuring atmosphere was an air atmosphere.

The results are presented in Table 2.

TABLE 2

| | Thermal | |
|---|---|---|
| | decomposition | Melting |
| | temperature | point |
| | (° C.) | (° C.) |
| Ex. 1 | 330 | 3 |
| Ex. 2 | 310 | <−70 |
| Ex. 3 | 322 | −20 |
| Ex. 4 | 361 | <−70 |
| Comp. | 342 | 59 |
| Ex. 1 | | |
| Comp. | 328 | 64 |
| Ex. 2 | | |
| Comp. | 302 | 92 |
| Ex. 3 | | |
| Comp. | 243 | <−70 |
| Ex. 4 | | |

### —Thermal Decomposition Temperature—

The ionic liquids of Examples 1 to 4 and Comparative Examples 1 to 3 had high heat resistance compared to Comparative Example 4 that was a non-ionic liquid.

Examples 1 to 3 and Comparative Examples 1 to 3 exhibited the similar degree of heat resistance, and Example 4 exhibited particularly high heat resistance.

### —Melting Point—

All of the ionic liquids of Examples 1 to 4 had the melting points equal to or lower than room temperature (25° C.) in comparison with Comparative Examples 1 to 3.

### «Antifriction Properties»

### —Production of Lubricant-Coated Hard Disk—

A magnetic disk having a cross-section structure as illustrated in FIG. 1 was produced. A lubricant solution used for dip coating was prepared using the solvent presented in Table 3 to give a concentration of 1.5 g/L. Note that, the lubricant solution was filtered using a syringe filter (0.2 μm).

Dip coating was performed by lifting the magnetic disk up from a glass container containing the lubricant solution at a speed of 50 mm/min.

Dip concentration conditions were systematically changed relative to each of the lubricants, and the dip concentration dependency of a film thickness was studied. A film thickness was measured by an ellipsometry (model number: M-2000, manufacturer: J. A. Woollam Co., Inc.). Film formation was performed in a manner that an average thickness of the lubricant layer formed with adjusting the dip concentration relative to each lubricant was to be 10 Å.

### —Test—

A coefficient of friction relative to the number of sliding motions was measured using the produced sample under the following test conditions, to thereby evaluate antifriction properties. The results are presented in Table 3.

### [Test Conditions]

By means of an automatic friction measuring device (manufacturer: Kyowa Interface Science Co., Ltd., model number: Triboster TS-501), measurement was performed under conditions of point contact (3 mm steel ball), weight: 15 g, speed: 1.7 mm/sec, distance: 20 mm, and the repeating number: 100 times.

TABLE 3

The number of
sliding motions

| | Solvent | 1 time | 100 times |
|---|---|---|---|
| Ex. 1 | Vertrel XF | 0.15 | 0.17 |
| Ex. 2 | | 0.19 | 0.20 |
| Ex. 3 | | 0.17 | 0.17 |
| Ex. 4 | | 0.17 | 0.18 |
| Comp. | EtOH/ | 0.09 | 0.10 |
| Ex. 1 | Hexane | | |
| Comp. | | 0.11 | 0.14 |
| Ex. 2 | | | |
| Comp. | Vertrel XF | 0.16 | 0.16 |
| Ex. 3 | | | |
| Comp. | | 0.10 | 0.10 |
| Ex. 4 | | | |

Ethanol(EtOH)/Hexane=2/8 (mass ratio)

All of the lubricants maintained the coefficient of friction of 0.20 or lower even after 100 times of sliding motions.

### «Comprehensive Evaluation»

The evaluation results above were ranked as follows, and moreover, a comprehensive evaluation was performed based on the following evaluation criteria. The results are presented in Table 4.

### <Ranking>

### [Solubility to Fluorine-Based Solvent]

### B Evaluation: Rank B

### C Evaluation: Rank C

### [Melting Point]

−30° C. or lower: Rank A
25° C. or lower: Rank B
Higher than 25° C.: Rank C

### [Heat Resistance (Thermal Composition Temperature)]

350° C. or higher: Rank A
300° C. or higher but lower than 350° C.: Rank B
Lower than 300° C.: Rank C

### [Coefficient of Friction (Abrasion Resistance)]

Coefficient of friction after sliding motions of 100 times was 0.20 or less: Rank B
Coefficient of friction after sliding motions of 100 times was greater than 0.20: Rank C

### [Evaluation Criteria of Comprehensive Evaluation]

I: The results were B or A in all of the 4 evaluations and include at least one A.
II: The results were B in all of the 4 evaluations.
III: One C was included in the results of the 4 evaluations.
IV: Two or more C were included in the results of the 4 evaluation.

TABLE 4

| | Example | | | | Comparative Example | | | |
|---|---|---|---|---|---|---|---|---|
| | 1 | 2 | 3 | 4 | 1 | 2 | 3 | 4 |
| Cation | 1-PFTEG substituted DBU | | | | Trimethylstearyl | | PFTEG | — |
| | | | | | ammonium | | amine | |
| Anion | PFBSI | CpSI | PFBS | TFSM | CpSI | TFSM | PFBS | — |
| Molecular | 500 | 500 | 500 | 500 | — | — | 500 | 2000 |
| weight of PFPE | | | | | | | | |
| Solubility to | B | B | B | B | C | C | B | B |
| fluorine-based | | | | | | | | |
| solvent | | | | | | | | |
| Melting point | B | A | B | A | C | C | C | A |
| Thermal | B | B | B | A | B | B | B | C |
| decomposition | | | | | | | | |
| temperature | | | | | | | | |
| Abrasion | B | B | B | B | B | B | B | B |
| resistance | | | | | | | | |
| Comprehensive | II | I | II | I | IV | IV | III | IV |
| evaluation | | | | | | | | |

Examples 1 to 4 exhibited excellent properties as the lubricants, which had all of solubility to a fluorine-based solvent, thermal properties, and abrasion resistance.

### INDUSTRIAL APPLICABILITY

The lubricant for magnetic recording medium of the present invention has excellent thermal stability and solubility to a fluorine-based solvent and is a liquid at room temperature, hence the lubricant for magnetic recording medium of the present invention can be suitably used for a magnetic recording medium of a high recording density.

### REFERENCE SIGNS LIST

11: substrate
12: undercoat layer
13: magnetic layer
14: protective carbon layer
15: lubricant layer
21: substrate
22: magnetic layer
23: protective carbon layer
24: lubricant layer
25: back coat layer

1. A lubricant for magnetic recording media comprising:
an ionic liquid including an anionic component and a cationic component,
wherein the anionic component includes a fluorine-containing chain having a number average molecular weight of 1,500 or less,
the cationic component is a cation of cyclic amidine, and
the cation of the cyclic amidine includes a fluorine-containing chain that is either a perfluoroalkyl chain or a perfluoropolyether chain.

2. The lubricant for magnetic recording media according to claim 1,
wherein the ionic liquid is represented by General Formula (1) below, 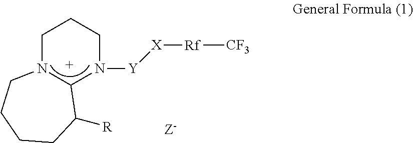
where, in General Formula (1), Rf is a perfluoropolyether chain having, as a repeating unit, a perfluoroalkyloxy chain having from 1 to 4 carbon atoms,
X is an alkylene group having 2 or more carbon atoms, an oxyalkylene group having 1 or more carbon atoms and 1 or more repeating units, or any combination thereof,
Y is a single bond or a divalent linking group,
R is a hydrogen atom or a hydrocarbon group having from 1 to 22 carbon atoms, and
Z⁻ is the anionic component.

3. The lubricant for magnetic recording media according to claim 1,
wherein the anionic component is a sulfonic acid anion including the fluorine-containing chain, a sulfonyl imide anion including the fluorine-containing chain, or sulfonyl methide anion including the fluorine-containing chain.

4. The lubricant for magnetic recording media according to claim 2,
wherein, in General Formula (I), the number of atoms in a straight chain connecting *1 and *2 of a divalent group represented by a structural formula below is 2 or greater,
*¹—Y—X—*².

5. A magnetic recording medium comprising:
a non-magnetic support;
a magnetic layer disposed on the non-magnetic support; and
the lubricant for magnetic recording media according to claim 1, where the lubricant is disposed on the magnetic layer.
